(19) United States
(12) Patent Application Publication
(10) Pub. No.: US 2008/0124161 A1
(43) Pub. Date: May 29, 2008

(54) HYBRID DESKTOP-PORTABLE PRINTER METHOD AND APPARATUS

(75) Inventors: Raul G. Palacios, Littleton, CO (US); Dean O. Miller, Littleton, CO (US)

Correspondence Address: SHERIDAN ROSS PC, 1560 BROADWAY, SUITE 1200, DENVER, CO, 80202, US

(73) Assignee: COGNITIVE SOLUTIONS, INC., Golden, CO (US)

(21) Appl. No.: 11/771,855

(22) Filed: Jun. 29, 2007

Related U.S. Application Data
(60) Provisional application No. 60/806,403, filed on Jun. 30, 2006.

(51) Int. Cl. B41J 3/42; B41J 2/315

(52) U.S. Cl. 400/74; 400/120.01

(57) ABSTRACT

A printer having a desktop unit and a portable unit that can be interconnected to the desktop unit is provided. The desktop unit provides a media supply. However, the desktop unit does not provide a print head. The portable unit provides a media supply and a print head. When the portable unit is interconnected to the desktop unit, the print head may be supplied with media from either the media supply of the desktop unit or the media supply of the portable unit.

### CROSS REFERENCE TO RELATED APPLICATIONS

This application claims the benefit of U.S. Provisional Application Ser. No. 60/806,403, filed Jun. 30, 2006.

### FIELD

The present invention relates to printer devices.

### BACKGROUND

Printers are commonly used to produce hard copy output in a variety of situations. One type of printer is the thermal printer. Generally thermal printers comprise an enclosure containing media on which images and/or text is printed, and various components used to accomplish the printing, such as a print head, print head assembly, control electronics and a power supply. In addition, electronic communication is established between the printer and a computer, such that the computer is able to issue print tasks to be executed by the printer. A thermal printer may operate as a direct thermal printer, in which images are formed on a specially treated paper or other media by applying heat directly to the surface of the media. Another type of thermal printer is the thermal transfer printer, in which an image is formed by applying heat to a ribbon, which causes the transfer of wax and/or resin from the ribbon to the media.

Different types of thermal printers are available such as a relatively larger desktop printer and a relatively smaller portable printer. Desktop printers typically use wired connections to communicate with the associated computer. However, wireless connections between a desktop printer and a computer are possible. In contrast, portable printers typically use a wireless connection to communicate with the associated host. Typically, desktop printers contain larger amounts of print media than do portable printers, due to a person's limited ability to carry the weight of a large media roll and the desire to keep the size of the portable printers as small as possible.

Examples of applications in which thermal printers have become prevalent include the ski industry, which commonly uses thermal printers to produce tickets at the point of sale on a durable label media. Another example is automotive service labeling, in which reminder labels for oil changes or other periodic maintenance procedures may be printed out on demand and placed in a customer's windshield. Examples of general business applications that use thermal printers include archive data labeling, asset inventory tracking, retail pricing, and media record tracking. Another example is the health care industry, which uses thermal printer technology in connection with laboratory sample identification, patient identification, pharmacy labeling, x-ray tracking, etc. In addition to including textual information or graphics, labels often include machine-readable barcodes.

Those who use thermal printers for these applications may find it advantageous to employ a desktop printer at times, and a portable printer at other times. An example of such a situation can be found in the ski industry. At certain times during the day, the ticket stand where lift tickets are sold may experience a high volume of customers. At such times, a technique known as “line busting” can provide faster service. In this technique, ticket sellers, having portable ticket printing systems, move through the crowd and sell tickets. At times of reduced customer volume, the “line busting” technique is no longer needed as customers may access the ticket stand in a relatively short time. Accordingly, only a desktop printer located at the ticket stand is needed. However, as can be appreciated, the cost of purchasing a separate printer may not be justifiable, especially if that printer is only usable in certain situations.

### SUMMARY

The present invention is directed to solving these and other problems and disadvantages of the prior art. In particular, embodiments of the present invention provide hybrid desktop-portable thermal printers having at least two media supplies contained in separable enclosures or chassis. More particularly, embodiments of the present invention provide a first media supply associated with a desktop unit and a second media supply associated with a portable unit. The portable unit, in addition to being associated with a media supply, may contain the various components that are used in connection with either the first media supply or the second media supply such as a print head assembly and control electronics. In addition, the portable unit may be provided with a rechargeable power supply or battery. The desktop unit, in addition to providing another media supply may also provide a recharging facility for the portable unit and a wireline or some other supplemental communication interface.

In accordance with embodiments of the present invention, the hybrid printer has two modes of operation. In a first mode of operation, the portable unit is attached to the desktop unit and may be provided with media from either its own media supply or the media supply associated with the desktop unit. The portable unit is also capable of receiving electronic communications from the desktop unit. In addition, a charging device may be provided within the desktop unit that operates to recharge the battery contained within the portable unit and/or to power the portable unit directly. In a second mode of operation, the portable unit is detached from the desktop unit and is provided with media only from its own media supply. In this mode of operation the portable unit receives electronic communications over a wireless link, and/or may produce output using stored information.

In accordance with embodiments of the present invention, the same printer is thus able to function both as a desktop printer and as a mobile printer. Additional features and advantages of embodiments of the present invention will become more readily apparent from the following discussion, particularly when taken together with the accompanying drawings.

### BRIEF DESCRIPTION OF THE DRAWINGS

FIG. 1 is a block diagram depicting components of a hybrid-desktop portable printer having a portable unit and a desktop unit in accordance with embodiments of the present invention;

FIG. 2 is a schematic depiction of a hybrid-desktop portable printer having a portable unit and a desktop unit in accordance with embodiments of the present invention;

FIG. 3 is a schematic depiction of a portable unit in accordance with embodiments of the present invention;

FIG. 4 is a schematic depiction of a desktop unit in accordance with embodiments of the present invention; and

FIG. 5 is a flow chart depicting aspects of a method for providing output in connection with a hybrid-desktop portable printer having separable portable and desktop units.

### DETAILED DESCRIPTION

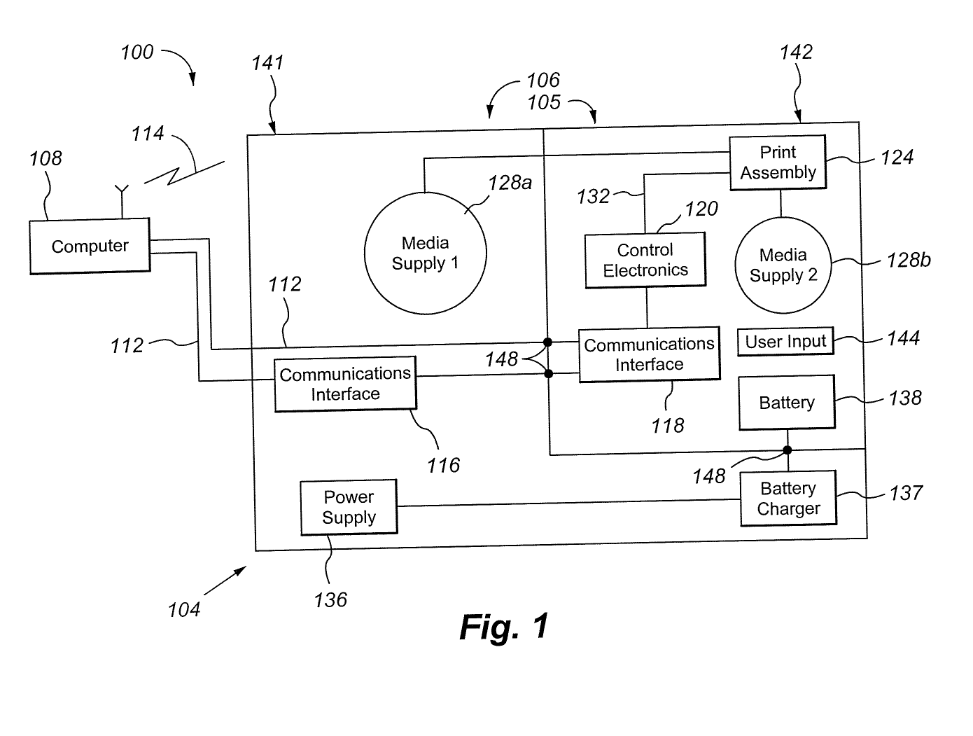

In FIG. 1, a system 100 comprising a hybrid-desktop portable printer 104 in accordance with embodiments of the present invention. The hybrid-desktop portable printer 104 includes a portable unit 105 and a desktop unit 106. As shown in FIG. 1, the hybrid printer 104 may be interconnected to a computational device or computer 108. In general, the hybrid-desktop portable printer 104 is a multiple media supply, single print head device, as described in detail herein. The computer 108 may be any general purpose or specialized computer including a desktop or laptop computer, personal digital assistant (PDA), cash register, server, workstation or any other device capable of providing a file or collection of data comprising image information to the printer 104 across a wired communication link 112 and/or a wireless communication link 114.

In accordance with embodiments of the present invention, the portable unit 105, in one mode of operation may be mated or operatively connected to the desktop unit 106. While mated with the desktop unit 106, the portable unit 105 is capable of receiving communications from the computer 108 through either the wired communication link 112 or through the wireless communications link 114. In an alternative mode of operation the portable unit 105 may be detached from the desktop unit 106 and operated independently from the desktop unit 106. In that respect, the portable unit 105 is capable of receiving communications from the wireless communications link 114. Alternatively, a wired communication link that is separate from the desktop unit 106 may connect the portable unit 105 to a computer 108.

The communication links 112 and 114 are not limited to any particular technology or protocol. Examples of wired communication links 112 include Universal Serial Bus (USB), IEEE 1394, RS-232, Ethernet, or other serial or parallel direct or shared connection. Examples of wireless communication links 114 include connections established in accordance with one of the various IEEE 802.11 standards, IrDA, Bluetooth or other wireless technologies or protocols. As can be appreciated by one of skill in the art, a printer, including a hybrid desktop-portable printer 104, does not need to be interconnected to a computer 108. Instead, a hybrid desktop-portable printer 104 may operate as a stand-alone printer in accordance with programming or instructions running on a printer operating system.

The hybrid desktop-portable printer 104 generally includes a desktop unit communications interface 116 and a portable unit communications interface 118. The desktop unit communications interface 116 may interconnect to the wired communication link 112. In a mode of operation in which the desktop unit 106 and the portable unit 105 are interconnected, the desktop unit interface 116 is capable of passing communications to and from the portable unit communication interface 118. The portable unit communications interface 118 may therefore be capable of receiving and transmitting communications to and from the computer 108 either through the desktop unit communication interface 116 or directly from the wireless communications link 114. In accordance with other embodiments of the present invention, the portable unit communication interface 118 may also receive and transmit communications sent via a wireless connection established through the desktop unit 106, or through a direct wire line connection established with the computer 108. Generally (but not always), only the wireless communications link 114 is available to the portable unit 105 when the portable unit 105 is detached from the desktop unit 106.

The portable communication interface 118 is in turn interconnected to control electronics 120. The control electronics 120 may comprise a processor capable of executing instructions stored in memory provided as part of the control electronics 120. Alternatively, or in combination the control electronics 120 may execute instructions received through the portable communication interface 118. The control electronics 120 are interconnected to a print assembly or means for printing 124. As illustrated in FIG. 1, these connections can be completed by dedicated signal lines 132.

The print assembly 124 is located in the portable unit 105 and is associated with a first media supply 128a or means for providing media, contained in or held by the desktop unit 106, and a second media supply 128b contained in or held by the portable unit 105. In general, as can be appreciated by one of skill in the art, a media supply can include a carrier for receiving print stock rolls and can also include components for establishing a media path. In a mode of operation in which the portable unit 105 is interconnected to the desktop unit 106, media can be provided to the print assembly 124 by either the desktop unit media supply 128a or the portable unit media supply 128b. In a mode of operation in which the portable unit 105 is detached from the desktop unit 106, media is supplied only from the portable unit media supply 128b. Media supplied by either the desktop unit 106 media supply 128a or the portable unit 105 media supply 128b can include for example paper or durable label media.

The printer 104 may additionally include a desktop unit power supply 136 and a portable unit power supply 138. The desktop unit power supply 136 may comprise a connection to AC line power and/or a battery. In addition, the desktop unit power supply 136 may include voltage transformers, rectifying circuits, voltage converters, or other circuitry needed to support the various power requirements of the included components. The portable unit power supply typically comprises a battery 138, but alternatively may comprise other devices, such as fuel cells, that are capable of being incorporated into a portable unit. In a mode of operation in which the portable unit 105 is interconnected to the desktop unit 106, the portable unit battery 138 may be capable of being recharged by means of a battery charger 137 disposed within the desktop unit 106. In this mode of operation, the battery 138 may continue to supply power to the portable unit 105 while being charged, or alternatively, power may be supplied to the portable unit 105 by the desktop unit power supply 136.

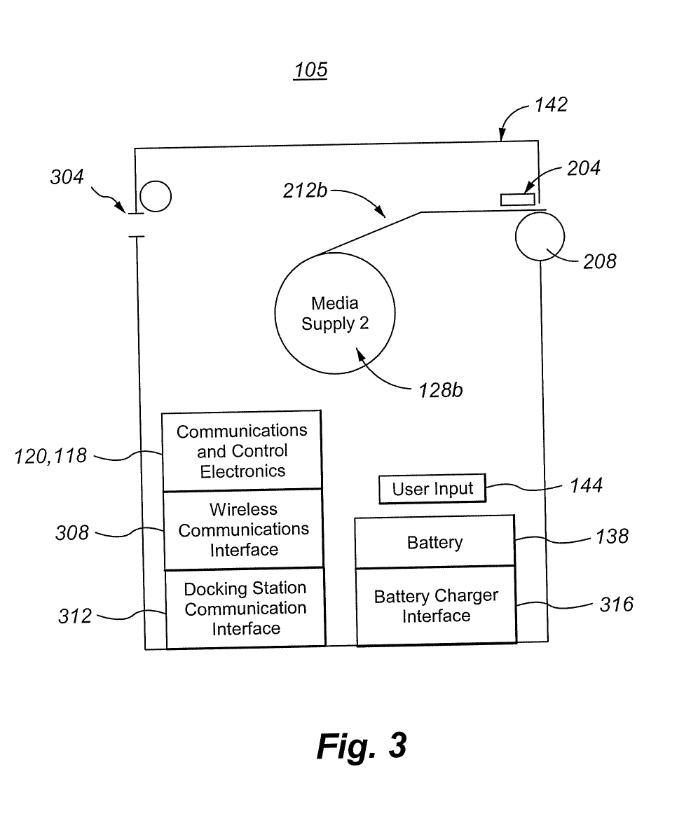

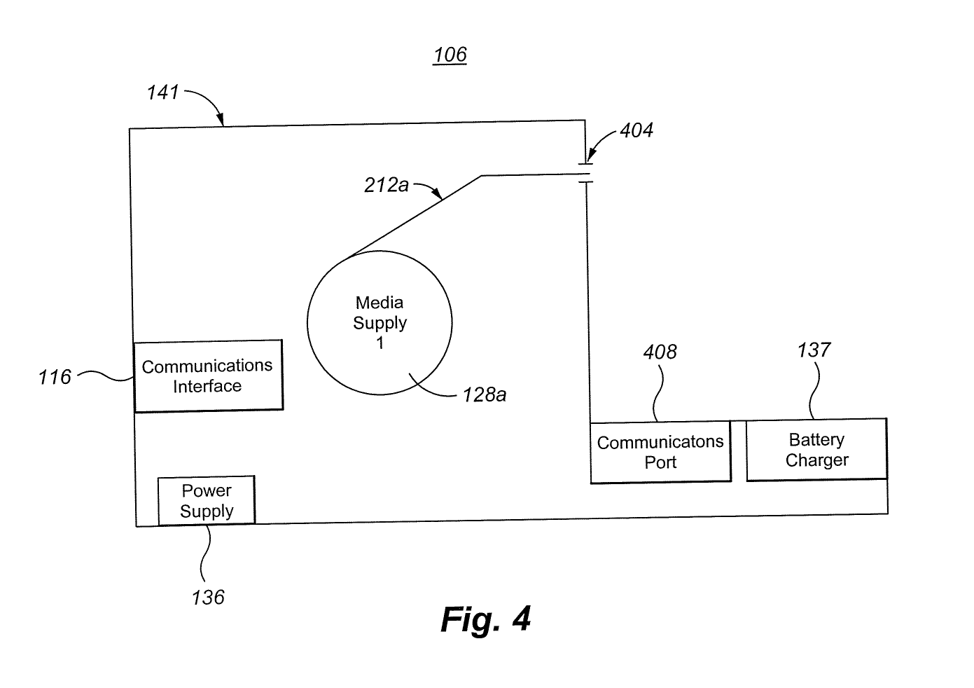

The printer 104 may also be associated with a first enclosure or chassis 141 to structurally interconnect or house the components of the desktop unit 106, and a second enclosure or chassis 142 to structurally interconnect or house the components of the portable unit 105. The first 141 and second 142 enclosures contain, respectively, a media output port 404, shown in FIG. 4, and a media input port 304, shown in FIG. 3. These two ports operate to pass media from the first media supply 128a associated with the desktop unit 106 to the print assembly 124 associated with the portable unit 105. Additionally, the first 141 and second 142 enclosures contain connections 148 that operate to pass communication signals and electrical power between the desktop unit 106 and the portable unit 105, as described above.

A user input or means for receiving a signal 144 may also be provided as part of the printer 104 in order to receive control inputs from a user. Control inputs entered through a user input 144 may include, for example, a command to turn the printer on or off or a command to initiate a print job. Another example of a control input that can be entered through a user input is data for inclusion in a label or other output to be printed. A user input 144 may include, for example, a keyboard, a keypad, or an abbreviated keyboard directly connected to or included in the printer 104. As can be appreciated by one of skill in the art, user input or other data can also be provided via a computer 108 and communication links, either wired 112 or wireless 114, during operation or use of the printer or during manufacture of the printer 104.

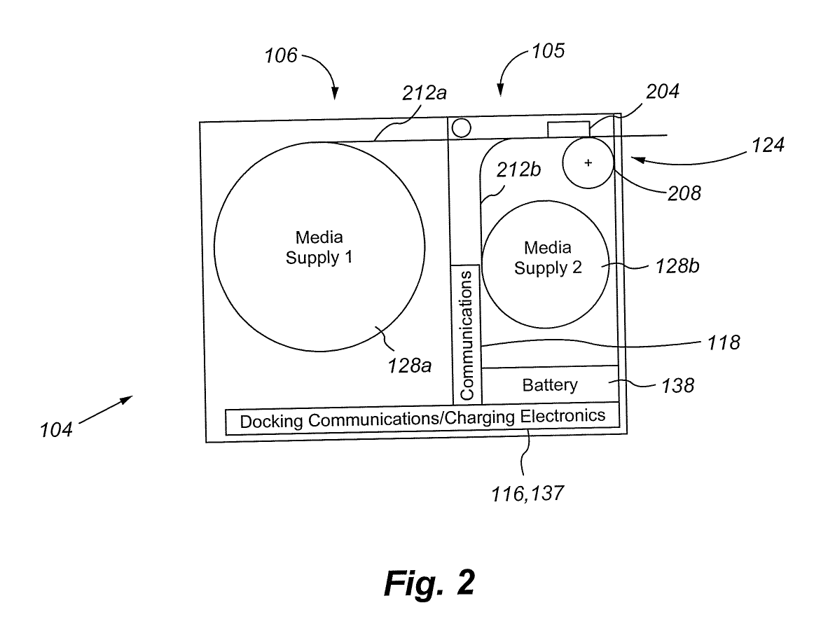

In FIG. 2, a hybrid desktop-portable printer 104 configuration in accordance with certain embodiments of the present invention is depicted. In the embodiment illustrated in FIG. 2, the print assembly 124 includes a print head 204 and a platon 208. Additionally, the print assembly 124 is shown as being operable to receive media 212a from both the first media supply 128a associated with the desktop unit 106, and media 212b from the second media supply 128b associated the portable unit 105. In accordance with embodiments of the present invention, the two supplies may contain different types of media 212a-b. Thus in a mode of operation in which the portable unit 105 is interconnected with the desktop unit 106, the user of the system 100 may choose to print using either of these two different media 212a-b types.

As can be appreciated by one of skill in the art, the print head 204 may include a thermal print head having a number of elements that can be energized such that heat is produced at a selected point along the length of the print head 204. By controlling the amount of time that the element remains energized, a dot or a line of a selected length can be created on the media 212a-b passing over the print head 204. The media 212 is passed or drawn over the print head 204 by the platen 208, which is driven by a motor (not shown) under the control of the control electronics 120. In a mode of operation in which the portable unit 105 is attached to the desktop unit 106, the print head 204 may be either supplied with media 212a by the desktop unit media supply 128a, or supplied with media 212b by the portable unit media supply 128b. In a mode of operation in which the portable unit 105 is detached from the desktop unit 106, the print head 204 may only be supplied with media 212b by the portable unit media supply 128b. The thermal print assembly depicted in FIG. 2 is shown by way of example and not limitation. It should be understood that other print assembly configurations, such as a thermal transfer type assembly, are within the scope of the invention.

FIG. 3 is a more detailed illustration of the portable unit 105 in accordance with embodiments of the present invention. As shown, the portable communication interface 118 can include a wireless communication interface 308 and a docking station communication interface 312. The wireless communication interface 308 is capable of establishing communications with the wireless communication link 114. Moreover, the wireless communication interface 308 is capable of communication over the link 114 whether or not the portable unit 105 is attached to the desktop unit 106. The desktop unit port interface 312 supports communications with or via the desktop unit 106 in a mode of operation in which the portable unit 105 is attached to the desktop unit 106. Also depicted is media input port 304, which allows the portable unit 105 to receive media 212a from the desktop unit 106. Additionally, FIG. 3 depicts the battery charger interface 316, which allows the battery 138 to be charged by means of the battery charger 137 associated with the desktop unit 106.

FIG. 4 is a more detailed illustration of the desktop unit 105 in accordance with embodiments of the present invention. The desktop unit 106 contains media 212a provided by media supply 128a that can be fed or drawn outward from the desktop unit 106 through media output port 404 for use by the portable unit 105. As mentioned above, the desktop unit media supply 128a is only available for use by the portable unit 105 in a mode of operation in which the portable unit 105 and the desktop unit 106 are interconnected. Also in this mode of operation, the desktop unit communications interface 1 16 may communicate with portable unit 105 through a communications port 408. As shown, the desktop unit 105 need not be associated with a print assembly other than the print assembly 124 of the portable unit 105.

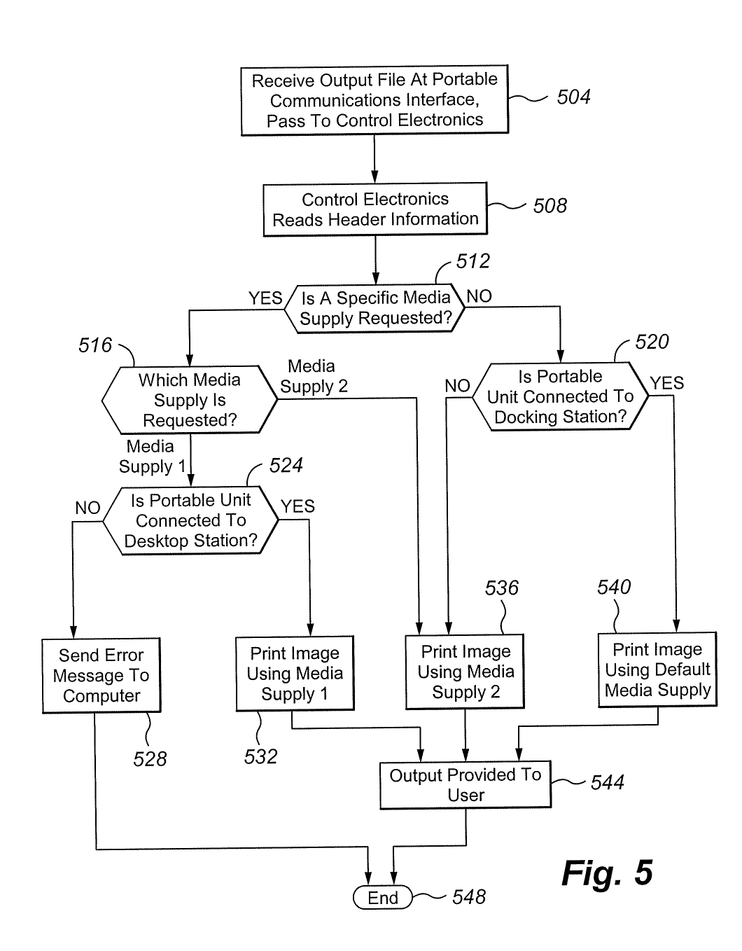

FIG. 5 is a flow chart illustrating aspects of a method for providing output from a hybrid desktop-portable printer 104 comprising a portable unit 105 and a desktop unit 106 in accordance with embodiments of the present invention. Initially, at step 504, an output file including header data or information and image data or information is received at the portable communication interface 118 of the hybrid desktop-portable printer 104. As described above, this output file may be received from the wireless communications link 114 if the portable unit 105 is either interconnected with or detached from the desktop unit 106. Alternatively, the output file can be passed to the portable communication interface 118 from a desktop unit communication port 408 through a wired connection if the portable unit 105 is attached to the desktop unit 106. After being received, the output file is then passed to the control electronics 120.

At step 508, the control electronics 120 reads the header information contained within the file to acquire information needed to determine the manner in which the file image is to be printed. At step 512, a determination is made as to whether the output file specifies or identifies a particular media supply 128a-b that is to be used to produce the output specified by the image data. The specification of a particular media supply 128a-b may comprise an explicit identification of the media supply 128a-b to be used to produce the desired output. The media supply 128a-b can also be specified inferentially. For example, the output file may specify that a particular media type is to be used. For example, the output file may specify that the member 212a, associated with the media supply 128a is to be used. Accordingly, the media supply 128a associated with the requested media type 212a is selected.

If it is determined that a particular media supply has been identified by information in the output file, a determination is then made as to which media supply is requested (step 516). If the media supply 128a associated with the desktop unit 106 is requested, a determination is then made as to whether the portable unit 105 is mated or operatively connected to the desktop unit 106 (Step 524). If the portable 105 and desktop 106 units are operatively connected, the image information from the output file is sent to the print head 204 and the print head 204 is supplied by the media supply 128a associated with the desktop unit 106 (step 532). However, if no such connection exists an error message is output by the printer 104 (step 528). If it is determined at step 516 that the media supply 128b associated with the portable unit 105 is requested, the image information is sent to the print head 204 and the print head 204 is supplied by the media supply 128b associated with the portable unit 105.

If it is determined at step 512 that no media supply 128 is specifically identified, a determination is made as to whether the portable unit 105 is attached to the desktop unit 106 (step 520). If such an attachment exists, the image information from the output file is sent to the print head 204 and the print head is supplied by the media 212 from a default media supply (step 540). As used herein, a default media supply may include a media supply that has been pre-selected for use where image information does not specify a particular media supply. A default media supply may also include a media supply that is available and appropriately loaded. If it is determined, at step 520, that the portable unit 105 is not connected to the desktop unit 106, the image information from the output file is sent to the print head 204 and the print head is supplied by the media 212b associated with the portable media supply 128b (step 536). After the image information is sent to the print head 204 and the printer output is provided to the user (step 544), the process may end (step 548).

In accordance with embodiments of the present invention, where a requested media supply 128 is out of media, media may instead be supplied to the print head 204 by the other media supply, provided that the alternate media supply is available to the print head 204. Alternatively, an error message may be sent to the computer and/or output to the user to indicate that the requested media is not available.

The foregoing discussion of the invention has been presented for purposes of illustration and description. Further, the description is not intended to limit the invention to the form disclosed herein. Consequently, variations and modifications concert with the above teachings, within the school of knowledge of the relevant art, or within the scope of the present invention. The embodiments described hereinabove are further intended to explain the best mode presently known of practicing the invention and to enable others skilled in the art to utilize the invention in such to other embodiments and for various modifications required by their particular application or use of the invention. It is intended that the appended claims be construed to include alternative embodiments to the extent permitted by the prior art.

What is claimed is:

1. A multiple mode printer device, comprising:
a portable unit, including:
a print head operable to receive a particular media and to produce an image on the particular media; and
a first media supply operable to provide a first media to the print head; and
a desktop unit, including:
a second media supply operable to provide a second media to the print head;
wherein:
in a first mode of operation wherein the desktop unit is interconnected to the portable unit, output is produced by the print head using either the first media provided by the first media supply or the second media provided by the second media supply; and
in a second mode of operation wherein the portable unit is disconnected from the desktop unit, output is only produced by the print head using the second media provided by the second media supply.

2. The device of claim 1, wherein in the second mode of operation the portable unit is separated from the desktop unit.

3. The device of claim 1, wherein the portable unit is at least one of:
a direct thermal printer; and
a thermal transfer printer.

4. The device of claim 1, wherein the portable unit includes a user input device, the user input device including at least one of:
a keyboard;
an abbreviated keyboard; and
a keypad.

5. The device of claim 1, wherein the output produced by the print head is based on an output file received from a computational device, the computational device including at least one of:
a desktop computer;
a laptop computer;
a server;
a workstation; and
a personal digital assistant.

6. The device of claim 1, wherein the output produced by the print head is based on an output file, and wherein the output file is transmitted over a wireless communication link between the computational device and the portable unit.

7. The device of claim 1, wherein at least one of the first and second media includes a durable media for use in printing labels.

8. The device of claim 1, wherein:
the desktop unit includes:
an AC line power cord; and
an AC line power supply interconnected to the AC line power cord; and
the portable unit includes:
a portable power source.

9. The device of claim 8, wherein in the first mode of operation the portable unit is interconnected to the AC line power supply and power is provided to the print head from the AC line power supply; and
wherein in the second mode of operation the print head is interconnected to the power source associated with the portable unit.

10. A method for providing output from a multiple mode printer having a portable unit capable of attachment to a desktop unit, comprising:
receiving a signal to initiate a print job;
determining whether a request has been made to print from either a first media supply or a second media supply, wherein the first media supply is associated with the desktop unit and the second media supply is associated with the portable unit;
in response to the first media supply being requested, determining whether the portable unit is attached to the desktop unit; and
printing an image using a print assembly associated with the portable unit;
wherein print media is provided to the print assembly by the first media supply if the first media was requested and the portable unit is attached to the desktop unit;
wherein print media is provided to the print assembly by the second media supply if the second media supply was requested.

11. The method of claim 10, wherein the signal is received from a computational device, the computational device being in wireless communication with the portable unit.

12. The method of claim 10, wherein the signal is received from a user input device associated with the portable unit.

13. The method of claim 10, further comprising:
generating an error message if the first media supply is requested and the portable unit is not attached to the desktop unit, wherein no further steps are taken.

14. The method of claim 10, wherein print media is provided by the second media supply if no media supply was requested and the portable unit is not attached to the desktop unit.

15. The method of claim 10, wherein the print media is provided by a predetermined default media supply if no media supply was requested and the portable unit is attached to the desktop unit.

16. The method of claim 10, wherein at least one of the first and second media includes a durable media for use in printing labels.

17. The method of claim 10, wherein the portable unit is at least one of:
a direct thermal printer; and
a thermal transfer printer.

18. The method of claim 10, wherein:
the desktop unit includes:
an AC line power cord; and
an AC line power supply interconnected to the AC line power cord; and
the portable unit includes:
a portable power source;
wherein when the portable unit is interconnected to the AC line power supply and power is provided to the print head from the AC line power supply; and
wherein when the portable unit is disconnected from desktop unit, the print head is interconnected to the power source associated with the portable unit.

19. A multiple mode printer device, comprising:
a desktop unit, including:
a first means for providing media;
a portable unit, including:
means for printing an image on media;
a second means for providing media;
wherein the portable unit can be connected to or disconnected from the desktop unit;
wherein while the portable unit is connected to the desktop unit, print media can be supplied to the means for printing by either the first means for providing media or the second means for providing media; and
wherein while the portable unit is disconnected from the desktop unit, print media can be supplied to the means for printing by the second means for providing media only.

20. The device of claim 19, further comprising:
means for receiving a signal including a request to initiate a print job.
